(19) United States
(12) Patent Application Publication
(10) Pub. No.: US 2009/0250887 A1
(43) Pub. Date: Oct. 8, 2009

(54) Cinquefoil chuck

(76) Inventor: Wen-Chen Ku, Wurih Township (TW)

Correspondence Address: Chiayuan Chang, 1217 Beach Park Blvd., Foster City, CA, 94404, US

(21) Appl. No.: 12/078,834

(22) Filed: Apr. 7, 2008

(51) Int. Cl. B23B 31/16

(52) U.S. Cl. 279/117

(57) ABSTRACT

An improved cinquefoil chuck comprises a clamping jaw mechanism provided with a plurality of clamping jaws that may release and close and that are connected to and driven by a driving mechanism. The clamping jaw mechanism is connected to and driven by an autorotation mechanism to rotate, and the cinquefoil chuck is used to make the clamping jaw mechanism automatically rotate for safe and easy operation.

### BACKGROUND OF THE INVENTION

1. Field of the Invention

This invention relates to an improved cinquefoil chuck and particularly to a chuck provided with a plurality of clamping jaws that close to clip goods and miscellaneous articles or release to place them.

2. Description of Related Art

In industrial circles, there are usually scattered articles and goods that must be handled, arranged, classified, placed, and stocked for management, so a cinquefoil chuck must be used to clamp, for example, worksite wastes, trash, recycled and classified parts for environmental protection, scattered articles in a workshop, and the like.

The cinquefoil chuck mainly comprises a clamping jaw mechanism provided with a plurality of clamping jaws that may release and close. The clamping jaws are connected to and driven by a driving mechanism to release and close. The plurality of clamping jaws look like petals of a plum flower, so the chuck is named cinquefoil chuck. Issues caused by a conventional cinquefoil chuck are described below.

The cinquefoil chuck is generally operated in a site where articles are piled. Gap lie between the clamping jaws, so the articles that are in the gaps cannot be clamped and then must be moved a little bit by an operation machine or chassis provided with the clamping jaws. However, if the operation machine or chassis is moved, an enough space in the workshop is a must. The work environment is generally too narrow to move, or when moving, the machine or chassis dangerously hit a person or article nearby.

Further, the conventional cinquefoil chuck is generally used to clamp the article. If the article to be clamped is too fluffy and occupies more space, the article must be squeezed and then clamped. Thus, man hour waste and inconvenience are caused. The conventional cinquefoil chuck in a weight is usually hanged in the air and is not provided with a structure and function that may squeeze a specific article at a specified angle.

Consequently, because of the technical defects of described above, the applicant keeps on carving unflaggingly through wholehearted experience and research to develop the present invention, which can effectively improve the defects described above.

### SUMMARY OF THE INVENTION

In consideration of the mentioned-above defects of prior art, this inventor considers to make improvement. In order to improve the defect in the prior art, a cinquefoil chuck is provided in this invention, comprising a clamping jaw mechanism provided with a plurality of clamping jaws that may release and close. The clamping jaws are connected to and driven by a driving mechanism to release and close, being characterized in that the clamping jaw mechanism is connected to and driven by an autorotation mechanism to rotate. Along with the autorotation mechanism that rotates, the cinquefoil chuck may rotate at an angle and capture a wanted article at a tuned angle of direction for safe and easy operation.

Besides, in this invention, an angle control part mat be connected to the top of chuck. The angle control part comprises an H-shaped clamping arm. The H-shaped clamping arm pivots a first vertical rod and a second vertical rod from two ends of a horizontal rod. The first vertical rod comprises an upper section pivoted to a lower section and serves as a section of flexible rod. A lower extreme of the lower section and a lower extreme of the second vertical rod are separately pivoted to the chuck. With the upper section that is flexible, an angle of bend between the upper section and the lower section, an included angle between the second vertical rod and the horizontal rod, and a deflection angle of the chuck may be changed.

The chuck in a specified weight at the adjustable angle may serves as a workpiece that is driven to squeeze the article. For example, the upper section serving as the section of flexible rod may be used to squeeze a metallic case, a can, a reinforcing steel, a sheet bar, a pasteboard box, a cardboard box and the like as the fluffy article.

### BRIEF DESCRIPTION OF THE DRAWINGS

FIG. 1 is a 3D view of this invention;

FIG. 2 is a 3D exploded view of most of the components according to this invention;

FIG. 3 is a top view of the status of rotation of this invention;

FIG. 4 is a top view of this invention;

FIG. 5 is a plane view of a chuck according to this invention the top of which is connected to an angle control part; and

FIG. 6 is a plane view of the service of the chuck according to this invention the top of which is connected to the angle control part.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

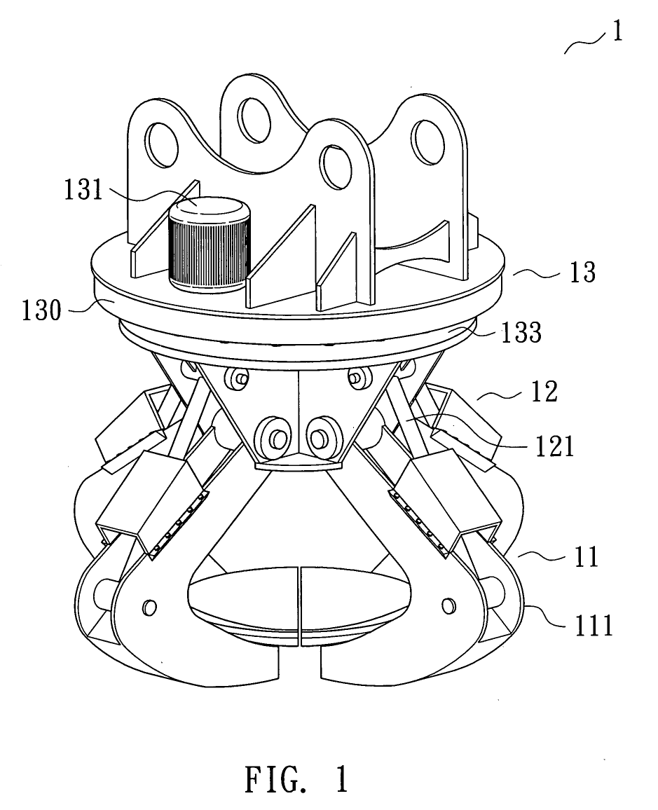

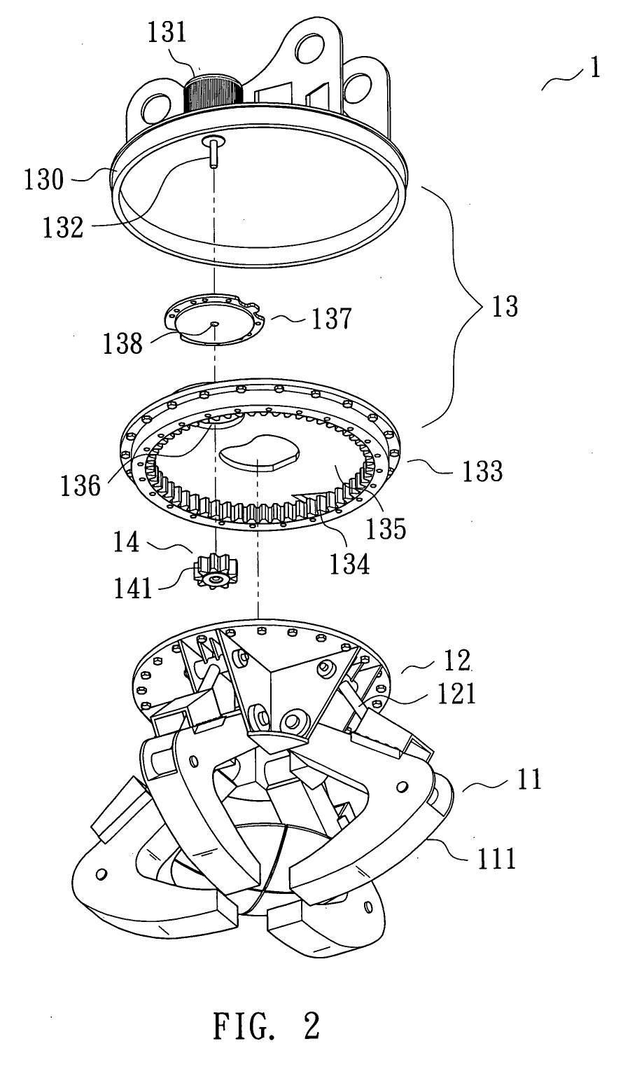

With reference to FIGS. 1 and 2, an improved cinquefoil chuck according to this invention is provided. The chuck (1) comprises a clamping jaw mechanism (11) provided with a plurality of clamping jaws (111) that may release and close; a driving mechanism (12) comprising a plurality of driving pressure cylinders (121) connected to the clamping jaws (111), such as an oil cylinder and an air pressure cylinder, which may drive the plurality of clamping jaws (111) to release and close; and an autorotation mechanism (13) that is connected to the top of clamping jaw mechanism (11) to drive and rotate.

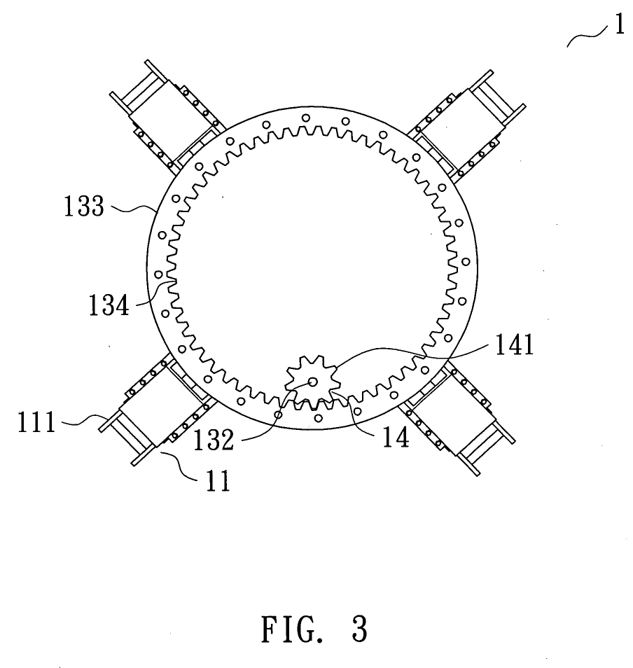

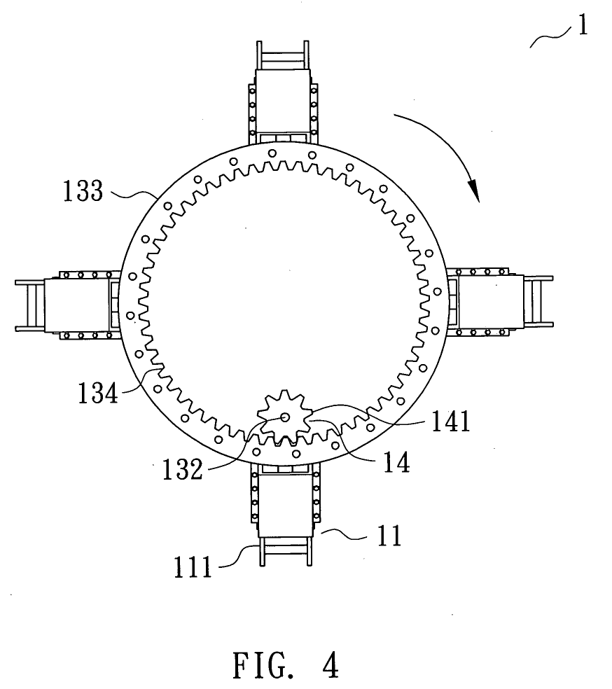

Further, in an embodiment, the autorotation mechanism (13) according to this invention may comprise a top mount (130) provided with an engine mechanism (131) that may be a motor supplying the power of operation, where a shaft (132) stretches; a passive ring (133) connected to the top of clamping jaw mechanism (11), in which a plurality of alternate teeth (134) are formed at an internal marginal zone of the passive ring (133) and a top tray (135) is provided on a top face of the passive ring (133) and provided with a thru hole (136) having a cover plate (137) provided with a thru hole (138) through which the shaft (132) passes; and a driving mechanism (14) that may be a gear connected to and driven by the shaft (132) of the engine mechanism (131), in which each tooth (141) of the gear engages the tooth (134) of the passive ring (133) to impede the passive ring (133) from running, as shown in FIGS. 3 and 4.

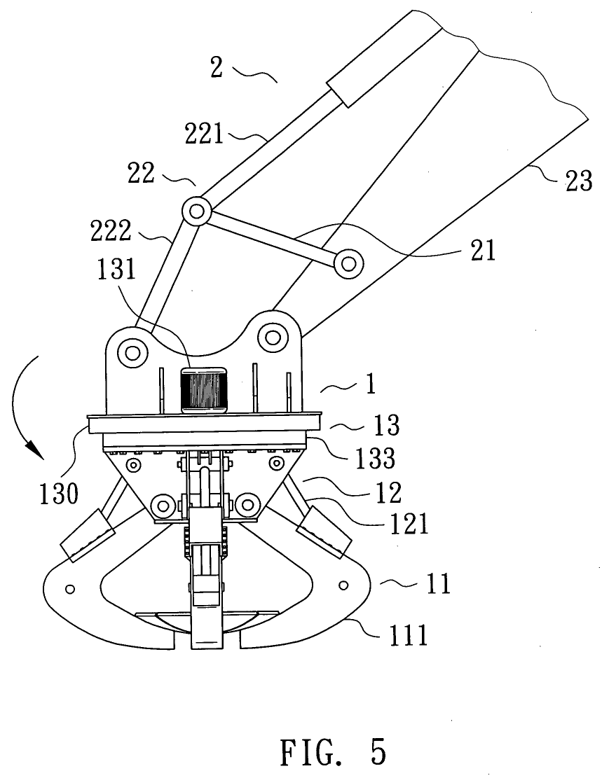

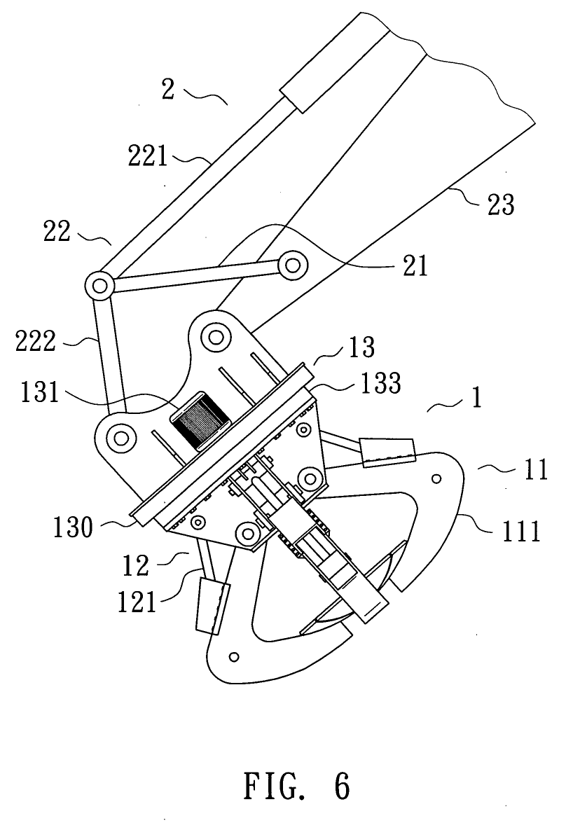

With reference to FIGS. 5 and 6, the top of chuck (1) according to this invention is connected to the angle control part (2). The angle control part (2) comprises an H-shaped clamping arm. The H-shaped clamping arm pivots a first vertical rod (22) and a second vertical rod (23) from two ends of a horizontal rod (21). The first vertical rod (22) comprises an upper section (221) pivoted to a lower section (222) and serves as a section of flexible rod. A lower extreme of the lower section (222) and a lower extreme of the second vertical rod (23) are separately pivoted to the chuck (1). With the upper section (221) that is flexible, an angle of bend between the upper section (221) and the lower section (222), an included angle between the second vertical rod (23) and the horizontal rod (21), and an angle of the chuck (1) may be changed.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A cinquefoil chuck, comprising:
a chuck, comprising:
a clamping jaw mechanism provided with a plurality of clamping jaws that may release and close;
a driving mechanism comprising a plurality of driving pressure cylinders connected to the clamping jaws;
an autorotation mechanism that is connected to the top of clamping jaw mechanism to drive and rotate; and
an angle control part, being provided at the top of chuck for connection, comprising an H-shaped clamping arm, and pivoting a first vertical rod and a second vertical rod from two ends of a horizontal rod, in which the first vertical rod comprises an upper section pivoted to a lower section and serves as a section of flexible rod and a lower extreme of the lower section and a lower extreme of the second vertical rod are separately pivoted to the chuck.

2. The cinquefoil chuck according to claim 1, wherein the autorotation mechanism comprises:
a top mount provided with an engine mechanism where a shaft stretches;
a passive ring connected to the top of clamping jaw mechanism, in which a plurality of alternate teeth are formed at an internal marginal zone of the passive ring; and
a driving mechanism that is a gear connected to and driven by the shaft of the engine mechanism, in which each tooth of the gear engages the tooth of the passive ring to impede the passive ring from running.
